(19) United States
(12) Patent Application Publication
(10) Pub. No.: US 2016/0314290 A1
(43) Pub. Date: Oct. 27, 2016

(54) COMPUTING DEVICE AUTHENTICATION BASED ON USER'S HAIR FOLLICLE PATTERN

(71) Applicant: INTEL CORPORATION, Santa Clara, CA (US)

(72) Inventors: Jim S. BACA, Corrales, NM (US); Tobias M. KOHLENBERG, Portland, OR (US); Mark PRICE, Placitas, NM (US); Min LIU, Portland, OR (US); Charles H. WINSTEAD, Portland, OR (US); Matthew ROYER, Hillsboro, OR (US)

(21) Appl. No.: 14/368,344

(22) PCT Filed: Dec. 23, 2013
(86) PCT No.: PCT/US2013/077584

§ 371 Date: Jun. 24, 2014

(51) Int. Cl. G06F 21/32; G06K 9/00

(52) U.S. Cl. CPC G06F 21/32; G06K 9/00885

(57) ABSTRACT

Technologies for authenticating a user to a computing device include determining a hair follicle pattern of a portion of the user's skin and comparing the determined hair follicle pattern to an authenticated hair follicle pattern to authenticate the user. The hair follicle pattern of the portion of the user's skin may, be generated by a camera of the computing device, and the authenticated hair follicle pattern may be stored in a secure storage of the computing device. Features of the computing device may be enabled based on the particular authenticated hair follicle pattern to which the determined hair follicle matches. Additionally, in some embodiments, one or more additional biometric authentications may be used, and the user may be authenticated based on the particular combination of the authenticated hair follicle pattern and the additional biometric authentication(s).

### BACKGROUND

Computing devices are becoming ubiquitous tools for both personal and business use. Many people interact with multiple computing devices, such as smartphones, tablet computers, and desktop computers, at various times throughout the day. To provide a level of security, many computing devices include some form of user authentication, typically in the form of a user password, to “unlock” the device and allow user interaction. Additionally, to further improve security, some computing devices are configured to time-out in response to a lack of user interaction, after which the user is required to re-enter the user password to unlock the device. In addition to the computing device itself, many activities involving the computing device may require a user password. For example, gaining access to various secured applications or environments, such as the user's work e-mail, personal e-mail, social media sites, online banking sites, and/or online shopping sites, may each require a user password. As the number of computing devices and secured applications/environments with which the user interacts on a daily basis continues to grow, the user's ability to remember passwords, especially “strong” passwords, for each device or application/environment becomes severely limited. As a compromise, many user's elect to utilize simplistic passwords or duplicate passwords across devices and/or environments to facilitate the user's memory of the passwords and/or quicken the authentication process. Of course, simplistic and re-used passwords can drastically reduce the level of security for the user and result in a catastrophic security breach should a single, simplistic password be improperly obtained.

In an attempt to alleviate the burden of memorization of passwords, some computing devices are enabled with biometric authentication. In a typical biometric authentication mechanism, the user is authenticated based on a physical trait of the user such as the user's fingerprint or retina characteristics. Although traditional biometric authentication can strengthen the security of the computing device, such biometric authentication may be prone to error (e.g., due to a dirty or injured finger) or otherwise considered overly invasive by the user (e.g., in the case of a retina scan).

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for authenticating a user based on a hair follicle pattern of the user;

FIG. 2 is simplified block diagram of at least one embodiment of a computing device of the system of FIG. 1;

FIG. 3 is a simplified flow diagram of at least one embodiment of a method for generating an authenticated hair follicle pattern of a user, which may be executed by the computing device of FIG. 2;

FIG. 4 is a simplified illustration of a user operating the computing device of FIG. 2 to generate a captured user image of a portion of the user's skin;

FIG. 5 is a simplified flow diagram of at least one embodiment of a method for determining a hair follicle pattern of user based on an captured image, which may be executed by the computing device of FIG. 2;

FIG. 6 is a simplified illustration of at least one embodiment of a captured user image showing a hair follicle pattern of the user;

FIG. 7 is a simplified flow diagram of at least one embodiment of a method for authenticating a user based on a hair follicle pattern of the user, which may be executed by the computing device of FIG. 2; and

FIG. 8 is a simplified flow diagram of at least one embodiment of a method for authenticating a user based on a hair follicle pattern of the user and another biometric authentication, which may be executed by the computing device of FIG. 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

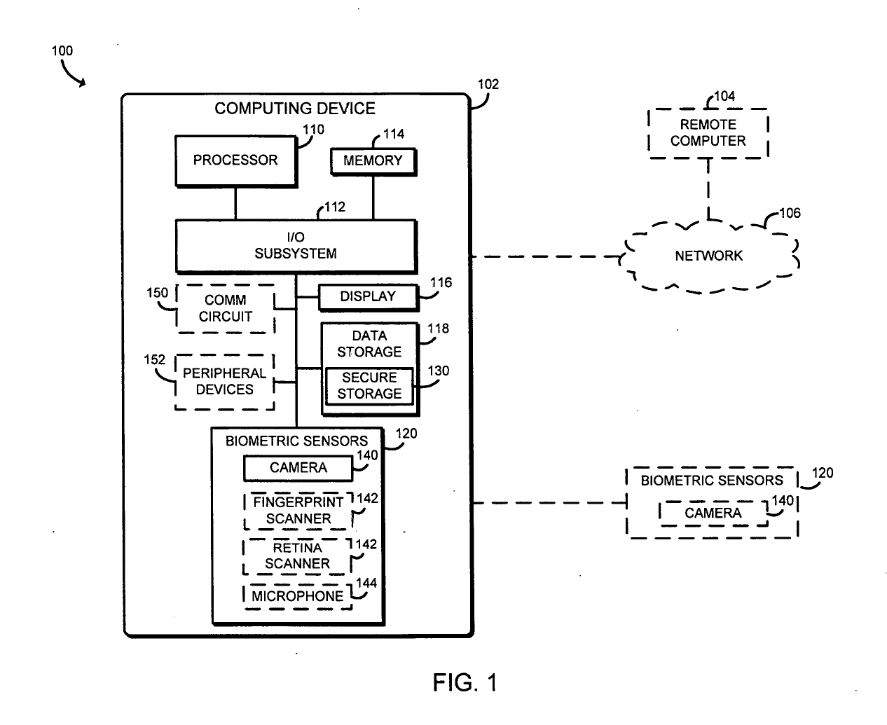

Referring now to FIG. 1, an illustrative system 100 for authenticating a user to a computing device includes a computing device 102 and, in some embodiments, a remote computer 104 with which the computing device 102 may communicate over a network 106. In use, the computing device 102 may authenticate a user based on a hair follicle pattern of a portion of the user's skin. To do so, the user may capture an image of a portion of the user's skin using a camera integrated with, or otherwise communicatively coupled to, the computing device 102. The computing device 102 analyzes the captured user image to determine a hair follicle pattern of the portion of the user's skin depicted in the captured image and compares the hair follicle pattern to a previously authenticated hair follicle pattern, which may be stored in the computing device 102. The authenticated hair follicle pattern may be embodied as an image of the user's skin that may be compared to the captured user image, as a digital template indicative of a hair follicle pattern of the user's skin, and/or as other data usable to compare to the user's captured image, or data derived therefrom, to determine whether a hair follicle pattern depicted in the user's captured image matches the authenticated hair follicle pattern. If the computing device 102 determines that the hair follicle patterns matches, the computing device 102 authenticates the user and unlocks, or otherwise enables, the computing device 102. In some embodiments, particular features of the computing device 102 may be selectively enabled based on the particular authenticated hair follicle pattern to which the user's hair follicle pattern is matched.

In addition, or alternatively, to unlocking/enabling the computing device 102, the computing device 102 may authenticate the user based on the user's hair follicle pattern to thereby authenticate the user to the remote computer 104 and/or secured applications or environments established on the computing device 102 and/or remote computer 104. In this way, the hair follicle pattern authentication performed by the computing device 102 may replace standard password authentication. For example, the user may authenticate to the computing device 102 using the user's hair follicle pattern to log into a secured website or web service (e.g., e-mail, banking, e-commerce, secured business environment, etc.) operated or maintained by the remote computer 104.

Additionally, in some embodiments, the computing device 102 may be configured to utilize multiple biometric authentications to authenticate the user. For example, in addition to authenticating the user based on a hair follicle pattern of the user as described above, the computing device 102 may require one or more additional biometric authentications such as, for example, fingerprint authentication, retina scan, ear print, voice identification, and/or other biometric authentication. The use of multiple biometric authentications may improve the overall security of the computing device 102. In embodiments in which multiple biometric authentications are used, the computing device 102 may authenticate the user based on the particular combination of the physical traits of used in the biometric authentications. For example, the authentication may require a hair follicle pattern from the user's right hand and a finger print from the user left hand. Alternatively, the authentication may require a hair follicle pattern from the user's periorbital region of the user's right eye and a retina scan of the user's left eye. As such, it should be appreciated that by requiring authentication of a particular combination of physical traits of the user may increase the overall security of the computing device 102.

Additionally, in embodiments in which multiple biometric authentications are used, particular or individual features of the computing device 102 may be enabled based on the particular combination of physical traits used in the biometric authentications. For example, the computing device 102 may enable cellular communications, but not the image gallery, in response to authentication of a hair follicle pattern of the user's right ear and an image print of the user's right ear. Additionally, the computing device 102 may enable all functionally in response to authentication of a hair follicle pattern of the user's right hand and a finger print of the user's right hand. In this way, varying levels of security of the computing device 102 may be enabled based on the particular combination of physical traits used in the biometric authentications.

The computing device 102 may be embodied as any type of computing device capable of authenticating the user based on a hair follicle pattern and performing the additional functions described herein. For example, the computing device 102 may be embodied as a smartphone, a cellular phone, a tablet computer, a notebook computer, a laptop computer, a desktop computer, a distributed computing system, a multiprocessor system, a consumer electronic device, a smart appliance, and/or any other computing device capable of user authentication as described below. As shown in FIG. 1, the illustrative computing device 102 includes a processor 110, an I/O subsystem 112, memory 114, a display 116, a data storage 118, and one or more biometric sensors 120. Of course, the computing device 102 may include other or additional components, such as those commonly found in a computer (e.g., various input/output devices), in other embodiments. Additionally, in some embodiments, one or more of the illustrative components may be incorporated in, or otherwise from a portion of, another component. For example, the memory 114, or portions thereof, may be incorporated in the processor 110 in some embodiments.

The processor 110 may be embodied as any type of processor capable of performing the functions described herein. For example, the processor may be embodied as a single or multi-core processor(s), digital signal processor, microcontroller, or other processor or processing/controlling circuit. Similarly, the memory 114 may be embodied as any type of volatile or non-volatile memory or data storage capable of performing the functions described herein. In operation, the memory 114 may store various data and software used during operation of the computing device 102 such as operating systems, applications, programs, libraries, and drivers. The memory 114 is communicatively coupled to the processor 110 via the I/O subsystem 112, which may be embodied as circuitry and/or components to facilitate input/output operations with the processor 110, the memory 114, and other components of the computing device 102. For example, the I/O subsystem 112 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 112 may form a portion of a system-on-a-chip (SoC) and be incorporated, along with the processor 110, the memory 114, and other components of the computing device 102, on a single integrated circuit chip.

The display 116 of the computing device 102 may be embodied as any type of display on which information may be displayed to a user of the computing device 102. For example, the display 116 may be embodied as, or otherwise use, any suitable display technology including, for example, a liquid crystal display (LCD), a light emitting diode (LED) display, a cathode ray tube (CRT) display, a plasma display, and/or other display usable in a mobile computing device. Additionally, in some embodiments, the display 116 may be embodied as a touchscreen display and include an associated touchscreen sensor (not shown) to receive tactile input and data entry from the user.

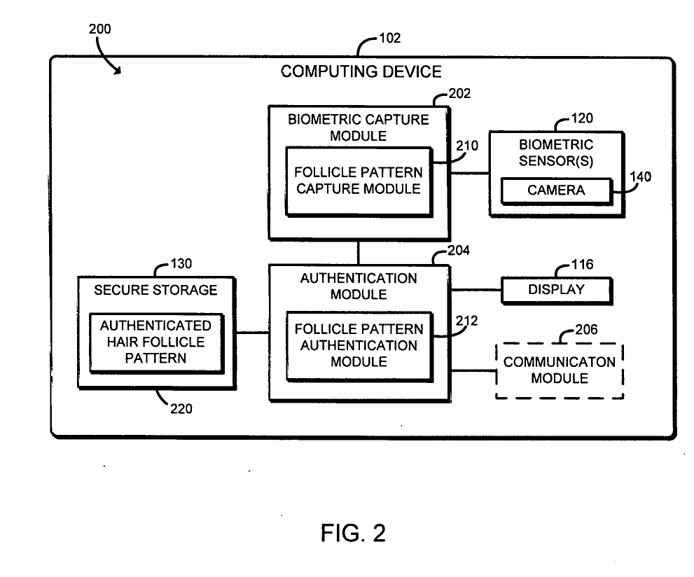

The data storage 118 may be embodied as any type of device or devices configured for short-term or long-term storage of data such as, for example, memory devices and circuits, memory cards, hard disk drives, solid-state drives, or other data storage devices. The data storage 118 may store various applications, program files, and other data used by the computing device 102. In the illustrative embodiment, the data storage includes a secure storage 130 in which an authenticated hair follicle pattern 220 (see FIG. 2) may be stored. As discussed in more detail below, the authenticated hair follicle pattern 220 may be embodied as an authenticated image of a portion of the user's skin including a hair follicle pattern, as a digital template of a hair follicle pattern of the user (e.g., generated based on an authenticated image of the user's skin), and/or other data indicative of a hair follicle pattern of the user that may be compared to a captured image of a portion of the user's skin, or data derived therefrom, to authenticate the user to the computing device 102.

The biometric sensors 120 may be embodied as one or more biometric sensors capable of capturing one or more physical traits of the user to authenticate the user to the computing device 102. In the illustrative embodiment, the biometric sensors 120 include a camera 140, which is operable by the user to capture an image of a portion of the user's skin including a hair follicle pattern. The camera 140 may be embodied as a digital camera or imaging device. In the illustrative embodiment, the camera 140 includes an electronic image sensor, such as an active-pixel sensor (APS), e.g., a complementary metal-oxide-semiconductor (CMOS) sensor, or a charge-coupled device (CCD). As discussed in more detail below, the computing device 102 may enable the camera 140 even while the computing device 102 is in a locked state (e.g., only the camera 140 and/or other emergency functionally may be enabled). As such, the user may capture an image of the user's skin while the remaining functionality of the computing device 102 is restricted. In some embodiments, such as those embodiments using multiple biometric authentication, the biometric sensors 120 may include additional biometric sensors such as, for example, a fingerprint scanner 142, a retina scanner 144, a microphone 146, and/or other biometric sensors.

In the some embodiments, the biometric sensors 120 may be integrated or incorporated into the computing device 102. For example, the camera 140 may be integrated into the computing device 102. Alternatively, in some embodiments, one or more of the biometric sensors 120 may be separate from the computing device 102 but communicatively coupled thereto as shown in FIG. 1 via the dashed biometric sensors 120. For example, in an embodiment in which the computing device 102 is embodied as a desktop computer, the camera 140 may be separate from the desktop computer but communicatively coupled thereto to.

In some embodiments, such as those embodiments in which the system 100 includes the remote computer 104, the computing device 102 may also include communication circuit 150. The communication circuit 150 may be embodied as any communication circuit, device, or collection thereof, capable of enabling communications between the computing device 102 and the remote computer 104 over the network 106. Depending on the particular type of communication modalities supported by the computing device 102, the communication circuit 150 may be embodied as, or otherwise include, a cellular communication circuit, a data communication circuit, and/or other communication circuit technologies. As such, the communication circuit 150 may be configured to use any one or more suitable communication technology (e.g., wireless or wired communications) and associated protocols (e.g., GSM, CDMA, Ethernet, Bluetooth©, WiMAX, etc.) to effect such communication.

The computing device 102 may also include one or more peripheral devices 152 in some embodiments. Such peripheral devices 152 may include any type of peripheral device commonly found in a typical computer device, such as various input/output devices. For example, the peripheral devices 152 may include various input buttons and switches, a keyboard, a mouse, speaker, microphone, and/or other peripheral devices.

The remote computer 104 may be embodied as any type of computing device including, but not limited to, a server, a router, a switch, a modem, a distributed computing system, a multiprocessor system, a consumer electronic device, a smart appliance, a desktop computer, a laptop computer, a smartphone, a cellular phone, a tablet computer, a notebook computer, and/or any other computer capable of facilitating communications with the computing device 102. In some embodiments, the remote computer 104 may be substantially similar to the computing device 102 and may include similar components as the computing device 102 such as, for example, a processor, memory, I/O subsystem, and data storage. The individual components of the remote computer 104 may be similar to the corresponding components of the computing device 102, the description of which is applicable to the corresponding components of the remote computer 104 and is not repeated herein so as not to obscure the present disclosure.

In use, the remote computer 104 may maintain a secure service or environment accessible by the computing device 102 upon successful authentication of the user. For example, the computing device 102 may authenticate the user based on a hair follicle pattern of the user as discussed below. Upon successful authentication of the user to the computing device 102, the computing device 102 may transmit a notification to the remote computer 104 to notify the remote computer 104 that the user has been authenticated. In this way, the user of the computing device 102 may authenticate to the remote computer 104 without the need to remember a password.

As discussed, the computing device 102 and the remote computer 104 may communicate with each other over the network 106. The network 106 may be embodied as any number of various wired and/or wireless voice and/or data networks. For example, the network 106 may be embodied as, or otherwise include, a cellular network, wired or wireless local area network (LAN), a wired or wireless wide area network (WAN), and/or a publicly-accessible, global network such as the Internet. As such, the network 106 may include any number of additional devices, such as additional computers, routers, and switches to facilitate communications among the devices of the system 100.

Referring now to FIG. 2, in the illustrative embodiment, the computing device 102 establishes an environment 200 during operation. The illustrative environment 200 includes a biometric capture module 202, an authentication module 204, and, in some embodiments, a communication module 206. In the illustrative embodiment, the biometric capture module 202 includes a follicle pattern capture module 210, and the authentication module 204 includes a follicle pattern authentication module 212. Each of the various modules of the environment 200 may be embodied as hardware, firmware, software, or a combination thereof.

The biometric capture module 202 manages the capturing of biometric data by the biometric sensors 120. As discussed above, the biometric sensors 120 may be configured to capture any type of physical trait of the user such as the user's hair follicle patter, finger print, retina pattern, etc. For example, in the illustrative embodiment, the follicle pattern capture module 210 manages the capturing of images of the user's skin via the camera 140. In some embodiments, the biometric capture module 202 controls the power state of the biometric sensors 120. For example, the biometric capture module 202 may enable (e.g., provide power to) the biometric sensors in response to a user interaction with the computing device 102. As discussed in more detail below, the biometric capture module 202 may enable the biometric sensors 120 (e.g., the camera 140) even while the computing device 102 is in a locked state to allow the user to utilize the biometric sensors to capture a particular physical trait of the user. In some embodiments, the biometric capture module 202 may also perform some amount of processing on the captured biometric data (e.g., perform image analysis on a captured image). The authentication module 204 receives the biometric data from the biometric capture module 202. In the illustrative example, the authentication module 204 receives the captured image of a portion of the user's skin from the biometric capture module 202 and determines a hair follicle pattern based on the captured image. To do so, the authentication module 204 may utilize any suitable image analysis or other technique to determine the hair follicle pattern as discussed in more detail below.

The authentication module 204 authenticates the user based on the captured image of the portion of the user's skin. For example, in the illustrative embodiment, the follicle pattern authentication module 212 retrieves an authenticated hair follicle pattern 220 from the data storage 118 (e.g., from the secure storage 130) and compares the authenticated hair follicle pattern 220 to the user's hair follicle pattern determined based on the captured image. If the follicle pattern authentication module 212 determines that the two hair follicle patterns match, the authentication module 204 authenticates the user to the computing device 102. The follicle pattern authentication module 212 may use any suitable methodology to compare the two hair follicle patterns to determine whether the hair follicle patterns match. For example, in embodiments in which the authenticated hair follicle pattern 220 is embodied as an authenticated image of a portion of the user's skin, the follicle pattern authentication module 212 may compare the authenticated image to the captured image using any suitable image analysis technique to determine whether a hair follicle pattern depicted in the authenticated image matches a hair follicle pattern depicted in the captured image. Alternatively, in embodiments in which the authenticated hair follicle pattern 220 is embodied as an authenticated digital template, the follicle pattern authentication module 212 may compare the authenticated digital image to the captured image, or data indicative of a hair follicle pattern derived from the captured image, to determine whether a hair follicle pattern depicted in the captured image matches the authenticated hair follicle pattern 220. Additionally, in embodiments in which the authenticated hair follicle pattern 220 is embodied as authenticated data indicative of a hair follicle pattern of the user, the follicle pattern authentication module 212 may compare the authenticated data to the captured image, or data indicative of a hair follicle pattern derived from the captured image, to determine whether a hair follicle pattern depicted in the captured image matches the authenticated hair follicle pattern 220. Of course, in other embodiments, the follicle pattern authentication module 212 may utilize any other suitable methodology to determine whether a hair follicle pattern depicted in the captured image matches the authenticated hair follicle pattern. Additionally, to allow for variability in the captured image and/or user error, the follicle pattern authentication module 212 may determine that the hair follicle patterns match within a reference degree of error in some embodiments.

As discussed above, in some embodiments, the computing device 102 may utilize multiple biometric authentication. In such embodiments, the authentication module 204 may include additional sub-modules to authenticate the user based on other physical traits of the user (e.g., finger print, retina pattern, etc.). The computing device 102 may authenticate the user based on a successful authentication of each physical trait. Additionally, as discussed above, the computing device 102 may enable particular features of the computing device 102 based on the particular combination of physical traits used to authenticated to the computing device 102.

In response to determining that the user is authenticated based on the a user's hair follicle pattern as discussed above, the computing device 102 may be configured to perform one or more authorized functions such as unlocking the computing device 102 or enabling various features of the computing device. For example, as discussed in more detail below, the computing device 102 may enable a particular feature based on the authenticated hair follicle pattern 220 used to authenticate the user and/or on the particular combination of physical traits used to authenticate the user. Additionally, in some embodiments, the computing device 102 may allow access to a software application or secured environment established on the computing device 102 and/or send a notification of authentication to the remote computer 104 as discussed below.

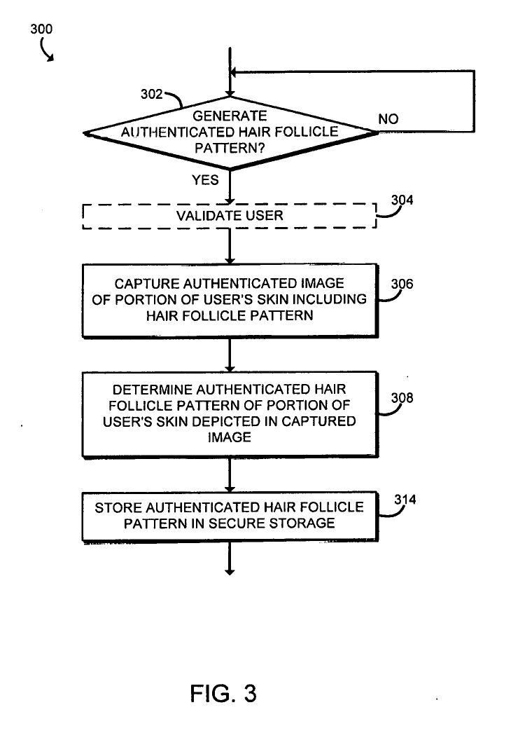

Referring now to FIG. 3, in use, the computing device 102 may execute a method 300 for generating an authenticated hair follicle pattern 220 of the user, which may be subsequently used to authenticate the user to the computing device 102. The method 300 begins with block 302 in which the computing device 102 determines whether the user desires to generate an authenticated hair follicle pattern 220. If so, the method 300 advances to block 304 in some embodiments. In block 304, the user is validated. The computing device 102 may utilize any suitable methodology to validate the user in block 304. For example, in some embodiments, the user may be requested to enter a global password or pin. The validation of the user ensures that the authenticated hair follicle pattern 220 cannot be modified by unauthorized users.

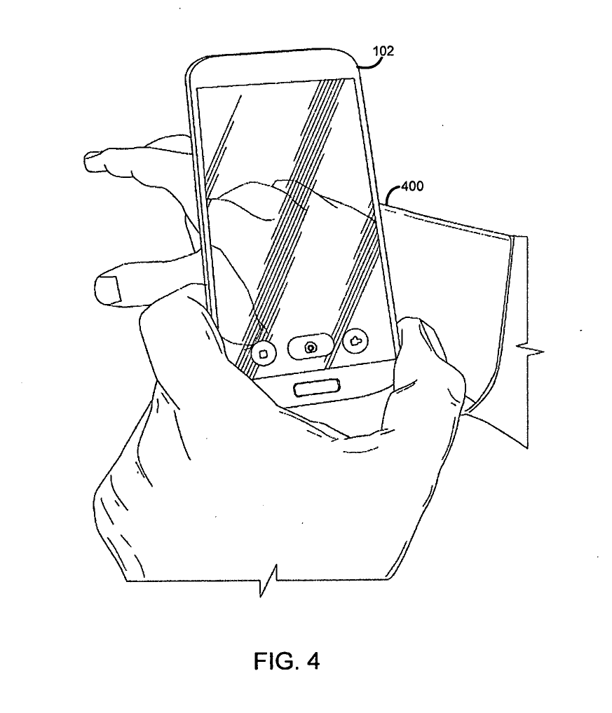

If the validation of the user is not successful, the computing device 102 does not allow generation or modification of the authenticated hair follicle pattern 220. However, if the user is successfully validated or if no validation is required, the method 300 advances to block 306 in which the computing device 102 captures an authenticated image of a portion of the user's skin. To do so, the user may operate the camera 140 of the computing device 102 to capture an image of the portion of the user's skin. Any portion of the user's skin having a suitable amount of hair growth may be used to generate the authenticated hair follicle pattern. For example, as shown in FIG. 4, the user may operate the computing device 102 to capture an image of a portion of the user's hand 400. Of course, in other embodiments, other areas of the user's skin may be used to generate the authenticated hair follicle pattern. For example, the user may capture an image of a portion of the user's skin located on either hand, arm, leg, ear, eye region, check, or other area having a suitable amount of hair follicles to define a hair follicle pattern.

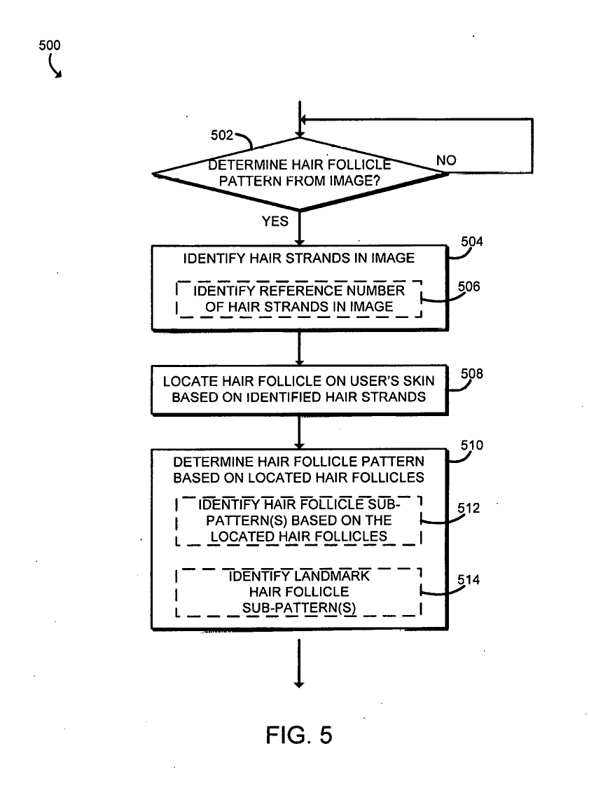

In block 310, the computing device 102 determines an authenticated hair follicle pattern 220 from the portion of the user's skin depicted in the captured image. To do so, the computing device 102 may utilize any suitable methodology to determine the authenticated hair follicle pattern 220 from the captured image. For example, the computing device 102 may use any suitable image analysis technique. In the illustrative embodiment, the computing device 102 may execute a method 500 for determining a hair follicle pattern of user based on an captured image as shown in FIG. 5. The method 500 begins with block 502 in which the computing device 102 determines whether to determine a hair follicle pattern from a captured image. If so, the method 500 advances to block 504 in which the computing device analyses the captured image to identify individual hair strands depicted in the captured image. The computing device 102 may utilize any suitable methodology, such as an image analysis technique, to identify the hair strands and may identify any number of hair strands based on the hair follicle pattern to be determined. For example, in block 506, the computing device 102 may be configured to identify a reference or minimum number of hair strands in the image. Additionally, in some embodiments, the computing device 102 may analysis only a portion or subset of the captured image for hair strands to reduce the computational load of the computing device 102.

After the computing device 102 has identified the individual hair strands depicted in the captured image, the method 500 advances to block 508 in which the computing device 102 locates a hair follicle of the portion of the user's skin depicted in the image for each of the identified hair strands. Again, the computing device 102 may utilize any suitable methodology, such as an image analysis technique, to identify the hair follicle associated with each hair strand. For example, in some embodiments, the computing device 102 may trace the identified hair to a point of contact with the skin of the user and identify the point of contact as a hair follicle. In other embodiments, such as those embodiments in which the camera 140 has a high resolution, the computing device 102 may be able to identify the hair follicles directly on the skin of the user. Regardless, it should be appreciated that by initially identifying the hair strands depicted in the captured image, the identification of the associated hair follicle may be simplified, quickened, and/or have an increased accuracy.

In block 510, the computing device determines a hair follicle pattern based on the located hair follicles. The hair follicle pattern may include any number of individual hair follicles and, in the illustrative embodiment, includes a large number of individual hair follicles. Additionally, the located hair follicles that make up the determined hair follicle pattern may be close to each other or spread out over the portion of the user's skin captured in the image. Of course, not all hair follicles depicted in the captured image or located in block 508 need be used to determine the hair follicle pattern. For example, in some embodiments, only a subset of hair follicles within a certain area may be used for the hair follicle pattern such that neighboring hair follicles may or may not be included in the hair follicle pattern. Additionally, the hair follicle pattern may be embodied as a single, large pattern of hair follicles or may include a number of sub-patterns in some embodiments. As such, in some embodiments, the computing device 102 may identify hair follicle sub-patterns based on the located hair follicles in block 512. In such embodiments, the authenticated hair follicle pattern 220 may be formed from the collection of identified sub-patterns of hair follicles. Additionally, in some embodiments in block 514, the computing device 102 may identify one or more of the identified sub-patters of hair follicles as landmark hair follicle sub-patterns. In such embodiments, the computing device 102 may utilize the identified landmark hair follicle sub-patterns to align or orient the captured image and/or perform other image analysis based on the landmark hair follicle sub-patterns.

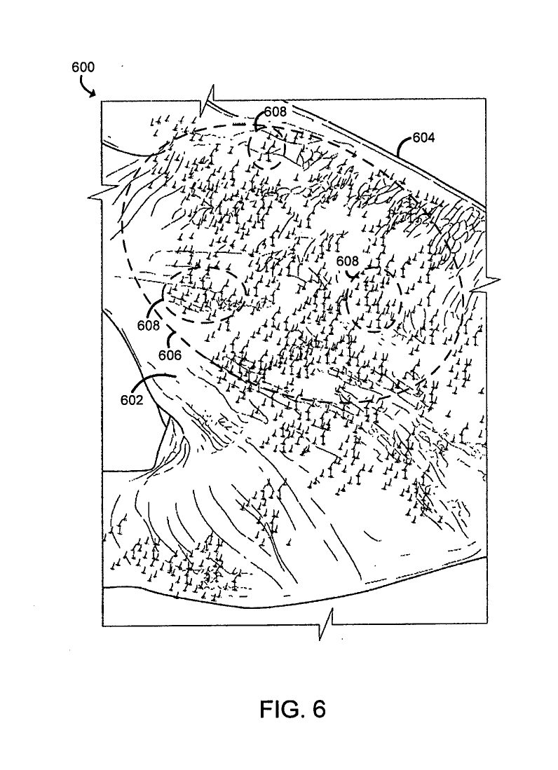

An illustrative captured image 600 of a portion of the user's skin 602 of the user's right hand 604 is shown in FIG. 6. As can be seen, the user's hand 604 has a large number of hairs and associated hair follicles. As such, in some embodiments, the computing device 102 may identify a single, large pattern 606 of hair follicles as the authenticated hair follicle pattern. Alternatively, the computing device 102 may identify one or more sub-patterns 608 of hair follicles, which may jointly form the authenticated hair follicle pattern. Of course, as discussed above, not all of the hair follicles depicted in the captured image 600 or lying within a pattern boundary 606, 608 may be included in the authenticated hair follicle pattern.

Referring back to FIG. 3, after the authenticated hair follicle pattern 220 has been determined in block 308, the method 300 advances to block 314. In block 314, the computing device 102 stores the authenticated hair follicle pattern 220 in the secure storage 130 of the data storage 118. Additionally, in some embodiments, the authenticated hair follicle pattern 220 may be stored in an encrypted or otherwise secure state.

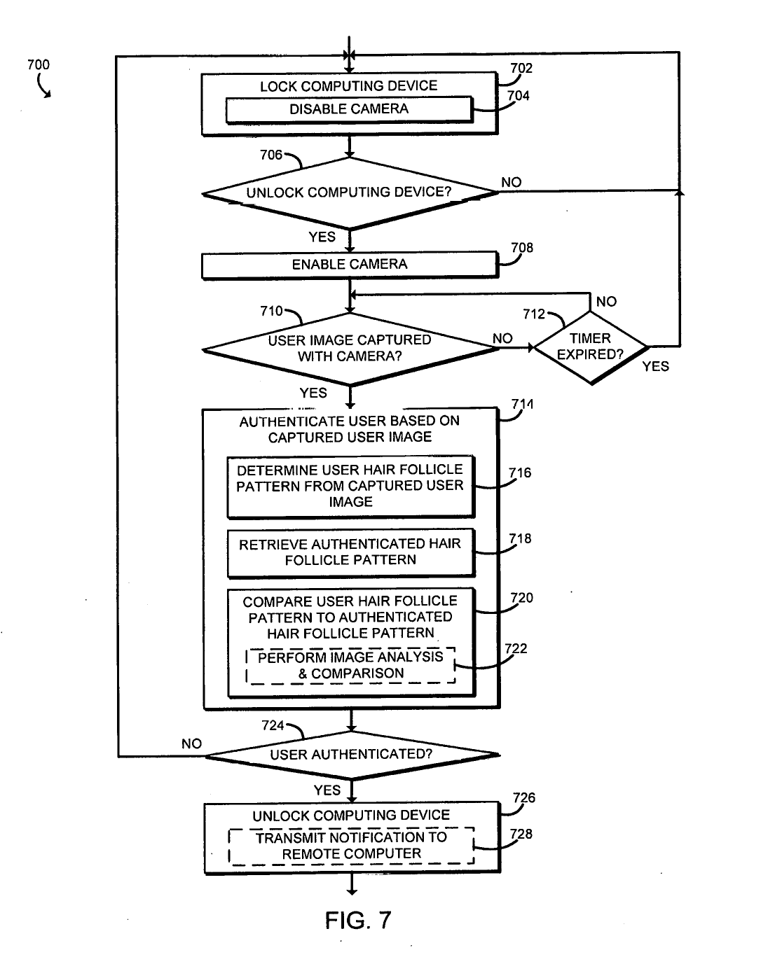

Referring now to FIG. 7, in use, the computing device 102 may execute a method 700 for authenticating a user based on a hair follicle pattern of the user. The method 700 begins with block 702 in which the computing device 102 enters a locked state. The computing device 102 may enter the locked state in response to any one of a number of different conditions such as an expiration of a time period since the last user interaction, in response to a user command or selection, based on a defined schedule, in response to detection of a security event, after initial boot, and/or other situations. Additionally, in some embodiments, the computing device 102 may enter the locked state some time prior to the execution of the remaining blocks of FIG. 7. While in the locked state, the computing device 102 may be inoperable or particular features or functionality of the computing device 102 may be disabled. For example, in a typical communication device such as a smart phone, the communication device has limited data entry functionality so as only to allow the user to enter a password. In the illustrative embodiment, the camera 140 is initially disabled while the computing device 102 is in the locked state in block 704.

In block 706, the computing device 102 determines whether the user desires to unlock the computing device 102. For example, the user may interact with the computing device 102 in some manner to provide an indication of the desire to unlock the computing device 102. For example, the user may swipe across a touchscreen display 116, select a button, or otherwise interact with the computing device 102.

If the computing device 102 determines that the user desires to unlock the computing device 102, the method 700 advances to block 708 in which the camera 140 is enabled. It should be appreciated that the camera 140 may be enabled in block 708 while the computing device 102 remains in the locked state such that other functionality of the computing device 102 is disabled or otherwise limited. The camera 140 is enabled to allow the user to capture an image of a portion of the user's skin as discussed above. As such, in block 710, the computing device 102 determines whether a user image has been captured. If not, the method 700 advances to block 712 wherein the computing device 102 determines whether a timer has expired. If not, the method 700 loops back to block 710 to continue monitoring for the capture of a user image. However, if the timer has expired, the method 700 loops back to block 702 in which the camera 140 is again disabled and the computing device 102 remains in the locked state. The length of the timer may be dependent on the type of computing device 102, preset to a standard value, or be user adjustable. It should be appreciated that the user of the timer in block 712 facilitates the computing device 102 disabling the camera 140 in the event of an inadvertent interaction by the user, for example.

If the computing device 102 determines that a user image has been captured in block 710, the method 700 advances to block 714 in which the computing device 102 authenticates the user based on the captured user image. To do so, in block 716, the computing device 102 determines a hair follicle pattern of a portion of the user's skin depicted in the captured image in block 716. Again, the computing device 102 may utilize any suitable methodology to determine the hair follicle pattern from the captured image. For example, the computing device 102 may use any suitable image analysis technique. In the illustrative embodiment, similar to when generating the authenticated hair follicle pattern, the computing device 102 may execute the method 500 for determining a hair follicle pattern based on an captured image as discussed above and shown in FIG. 5. If the computing device 102 is unable to detect any hair follicle pattern in the captured image (e.g., the image does not capture any portion of the user skin), the method 700 may abort or otherwise loop immediately back to block 702.

In block 718, the computing device 102 retrieves the authenticated hair follicle pattern 220 from the secure storage 130 of the data storage 118. As discussed above, the authenticated hair follicle pattern 220 may be stored in an encrypted state and, in such embodiments, may be decrypted in block 718. Subsequently, in block 720, the computing device 102 compares the hair follicle pattern determined in block 716 and the authenticated hair follicle pattern 220. To do so, the computing device 102 may utilize any suitable methodology to compare the two hair follicle patterns depending on, for example, the state in which the authenticated hair follicle pattern is stored in the secure storage 130 as discussed above in regard to follicle pattern authentication module 212 of FIG. 2. For example, the computing device 102 may compare an authenticated image of the authenticated hair follicle pattern 220 to the captured user image in block 720. In such embodiments, the computing device 102 may utilize any suitable image analysis to compare the two images including, for example, use of the landmark hair follicle sub-patterns to align the authenticate image of the authenticated hair follicle pattern 220 with the capture user image of the user's hair follicle pattern.

As discussed above, the computing device 102 compares the hair follicle patterns to determine whether the two hair follicle patterns match. Again, to allow for variability in the captured user image and/or user error, the computing device 102 may determine that the hair follicle patterns match within a reference degree of error in some embodiments. If the computing device 102 determines that the authenticated hair follicle pattern 220 and the user follicle hair pattern depicted in the captured image match, the computing device 102 authenticates the user. However, if the two follicle hair patterns do not match, the user is not authenticated. As such, in block 724, the computing device determines whether the user has been authenticated. If not, the method 700 loops back to block 702 in which the camera 140 is again disabled and the computing device 102 remains in the locked state.

However, if the computing device 102 determines that the user is authenticated in block 724, the method 700 advances to block 726 in which the computing device 102 is unlocked. In some embodiments, the computing device 102 may be unlocked to a fully functional state in block 726, allowing the user to fully use the computing device 102. Alternatively, in some embodiment, particular features of the computing device 102 may be unlocked based on the authenticated hair follicle pattern 220 used to authenticate the user. For example, the computing device 102 may store more than one authenticated hair follicle pattern 220 in the secure storage 130 and compare each authenticated hair follicle pattern to the user's hair follicle pattern depicted in the captured image in block 714 to authenticate the user. Depending on the particular authenticated hair follicle pattern 220 that was successfully used to authenticated the user, different features of the computing device 102 may be unlocked in block 726. In this way, different levels of access may be provided by the computing device 102.

In embodiments in which the system 100 includes the remote computer 104, the computing device 102 may send a notification to the remote computer 104 in block 728. The notification may inform the remote computer 104 that the user has successfully authenticated to the computing device 102. In such embodiments, the computing device 102 may or may not be in a locked state during execution of the method 700. For example, the user may be authenticated to the computing device 102 during an unlocked state of the computing device 102 as a proxy for authenticating directly to the remote computer 104 (e.g., in place of submitting a password to the remote computer 104).

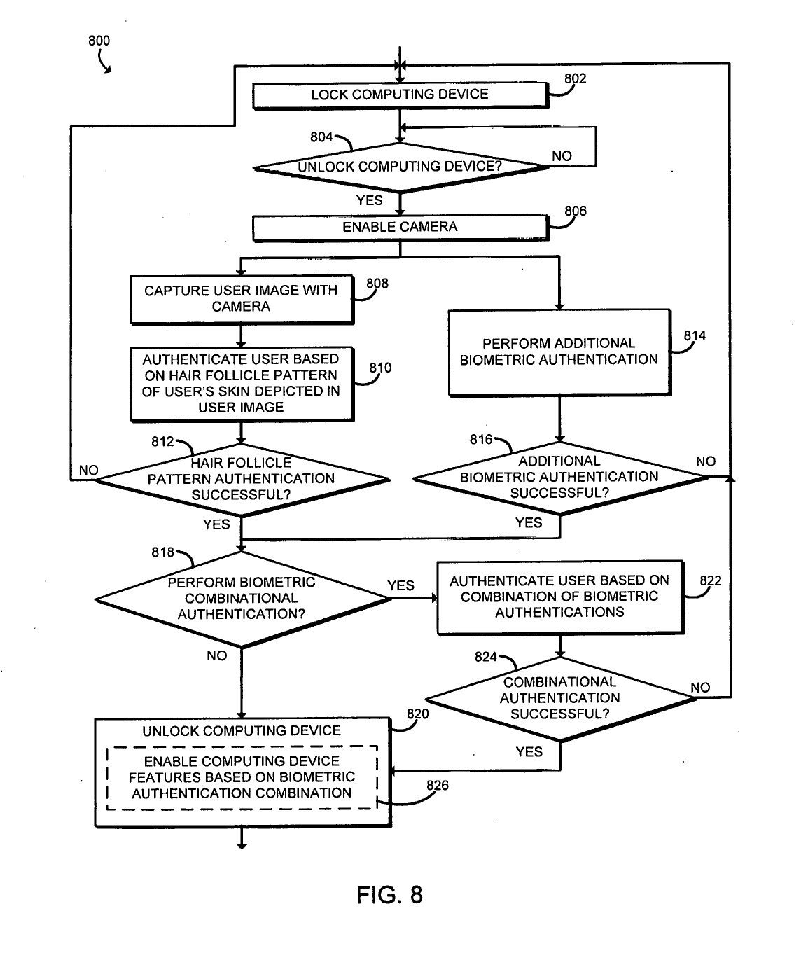

Referring now to FIG. 8, as discussed above, the computing device 102 may authenticate the user based on multiple biometric authentications in some embodiments. To do so, the computing device 102 may execute a method 800 for authenticating a user based on a hair follicle pattern of the user and one or more additional biometric authentications. The method 800 begins with block 802 in which the computing device 102 enters a locked state as discussed above with regard to method 700. While in the locked state, the camera 140 may be disabled. In block 804, the computing device 102 determines whether the user desires to unlock the computing device 102 (e.g., via detection of some interaction by the user with the computing device 102). If so, the method 800 advances to block 806 in which in which the camera 140 is enabled. The method 800 subsequently branches to multiple biometric authentications routines. For example, in blocks 808-812, the computing device 102 performs a biometric authentication of the user based on a user hair follicle pattern as discussed in detail above in regard to method 700. For example, in block 808, an image of a portion of the user's skin is captured, and the user is subsequently authenticated in block 810 based on the authenticated hair follicle pattern 220 and the user hair follicle pattern depicted in the captured image as discussed above in regard to block 714 of method 700. In block 812, the computing device 102 determines whether the hair follicle pattern authentication was successful. If not, the method 800 loops back to block 802, regardless of the success of any other biometric authentication, wherein the computing device remains in the locked state.

In addition to the hair follicle pattern authentication of blocks 808-812, the computing device 102 performs at least one additional biometric authentication in block 814. The additional biometric authentication(s) may be embodied as any type of biometric authentication including, but not limited to, another hair follicle pattern authentication (e.g., of a different area of the user's skin), a fingerprint authentication, a retina scan, an ear print, a voice identification, and/or other biometric authentication. Such additional biometric authentication may be performed in a standard manner. In block 816, the computing device 102 determines whether the additional biometric authentication(s) was successful. If not, the method 800 loops back to block 802, regardless of the success of the hair follicle pattern authentication of blocks 808-812, wherein the computing device 102 remains in the locked state.

Referring back to blocks 812 and 816, if the hair follicle pattern authentication of blocks 808-812 and each of the additional biometric authentications are successful, the method 800 advances to block 818. In block 818, the computing device 102 determines whether to perform biometric combinational authentication. That is, the computing device 102 determines whether to authentication the user not only on the successful multiple biometric authentications, but also on the particular combination of biometric authentications. If biometric combinational authentication is not desired in block 818, the user is authenticated based on the successful authentication of the multiple biometric authentications, and the method 800 advances to block 820 in which the computing device 102 is unlocked. For example, the computing device 102 may be unlocked to a fully functional state in some embodiments.

Referring back to block 818, if the computing device 102 determines that biometric combinational authentication should be performed, the method 800 advances to block 822. In block 822, the computing device 102 authenticates the user based on the particular combination of the physical traits used in of biometric authentications in blocks 812, 816. For example, successful authentication may require authentication of the hair follicle pattern of the user's right hand and a retina scan of the user's left eye or a hair follicle pattern of the user's right ear and a print of the user's right ear. Again, it should be appreciated that by requiring authentication of a particular combination of physical traits of the user may increase the overall security of the computing device 102.

In block 824, the computing device 102 determines whether the user is authenticated based on the combination of physical traits used in the biometric authentications. If not, the method 800 loops back to block 802 in which the computing device 102 remains in the locked state. However, if the user is authenticated based on the combination of physical traits used in the biometric authentications, the method advances to block 820 in which the computing device 102 is unlocked. Additionally or alternatively, in some embodiments, particular features of the computing device 102 may be enabled based on the combination of physical traits used in the biometric authentications in block 826. For example, as discussed above, the computing device 102 may enable cellular communications, but not the image gallery, in response to authentication of a hair follicle pattern of the user's right ear and an image print of the user's right ear. Alternatively, the computing device 102 may enable all functionally in response to authentication of a hair follicle pattern of the user's right hand and a finger print of the user's right hand. In this way, the computing device 102 may facilitate different levels of access based on the combination of physical traits used to biometrically authenticate the user.

### EXAMPLES

Illustrative examples of the devices, systems, and methods disclosed herein are provided below. An embodiment of the devices, systems, and methods may include any one or more, and any combination of, the examples described below.

Example 1 includes a computing device for authenticating a user based on a physical trait, the computing device comprising a biometric capture module to receive an image of a portion of user's skin from a camera while the computing device is in a locked state; an authentication module to determine a hair follicle pattern of the portion of the user's skin based on the image, retrieve the authenticated hair follicle pattern, compare the determined hair follicle pattern and the authenticated hair follicle pattern, and authenticate the user based on the comparison of the determined hair follicle pattern and the authenticated hair follicle pattern.

Example 2 includes the subject matter of Example 1, and wherein to determine the hair follicle pattern of the portion of the user's skin comprises to identify, in the image, a plurality of hair strands of the user extending from the portion of the user's skin; locate a hair follicle in the image for each identified hair strand; and determine a hair follicle pattern based on the located hair follicles.

Example 3 includes the subject matter of any of Examples 1 and 2, and wherein to locate the hair follicle for each identified hair strand comprises to trace each hair strand to a corresponding hair follicle of the portion of the user's skin depicted in the image.

Example 4 includes the subject matter of any of Examples 1-3, and wherein to determine the hair follicle pattern of the portion of the user's skin comprises to determine a plurality of hair follicle sub-patterns of the portion of the user's skin based on the image, wherein the hair follicle pattern comprises the plurality of hair follicle sub-patterns.

Example 5 includes the subject matter of any of Examples 1-4, and wherein to determine the hair follicle pattern of the portion of the user's skin comprises to determine a landmark hair follicle sub-pattern of the portion of the user's skin, and determine at least one additional hair follicle sub-pattern based on the landmark hair follicle sub-pattern, wherein the hair follicle pattern comprises the landmark hair follicle sub-pattern and the additional hair follicle sub-pattern.

Example 6 includes the subject matter of any of Examples 1-5, and wherein to compare the determined hair follicle pattern and the authenticated hair follicle pattern comprises to compare an image of the determined hair follicle pattern and an image of the authenticated hair follicle pattern.

Example 7 includes the subject matter of any of Examples 1-6, and, wherein to compare the determined hair follicle pattern and the authenticated hair follicle pattern comprises to compare first data indicative of the determined hair follicle pattern and second data indicative of the authenticate hair follicle pattern.

Example 8 includes the subject matter of any of Examples 1-7, and wherein to compare the determined hair follicle pattern and the authenticated hair follicle pattern comprises to determine whether the determined hair follicle pattern and the authenticate hair follicle pattern match.

Example 9 includes the subject matter of any of Examples 1-8, and wherein to authenticate the user comprises to unlock the computing device in response to a determination that the determined hair follicle pattern and the authenticate hair follicle pattern match.

Example 10 includes the subject matter of any of Examples 1-9, and wherein to authenticate the user comprises to enable a feature of the computing device that is identified based on the authenticated hair follicle pattern.

Example 11 includes the subject matter of any of Examples 1-10, and wherein to authenticate the user comprises to authenticate the user based on (i) the comparison of the determined hair follicle pattern and the authenticated hair follicle pattern and (ii) at least one additional biometric authentication of another physical trait of the user.

Example 12 includes the subject matter of any of Examples 1-11, and wherein to authenticate the user comprises to authenticate the user based on the combination of the authenticated hair follicle pattern and the another physical trait.

Example 13 includes the subject matter of any of Examples 1-12, and wherein to authenticate the user to enable a feature of the computing device that is identified based on the combination of the authenticated hair follicle pattern and the another physical trait.

Example 14 includes the subject matter of any of Examples 1-13, and further including a camera, and wherein to receive the image of the portion of the user's skin comprises to capture an image of the portion of the user's skin with the camera.

Example 15 includes the subject matter of any of Examples 1-14, and wherein to receive the image of the portion of the user's skin comprises to capture an image of the portion of the user's skin with a camera separate from the computing device and communicatively coupled to the computing device.

Example 16 includes the subject matter of any of Examples 1-15, and wherein the portion of the user's skin comprises a portion of the user's skin located on the user's hand, arm, ear, or periorbital region.

Example 17 includes the subject matter of any of Examples 1-16, and wherein the biometric capture module is further to enable the camera while the computing device is in the unlocked state in response to a user interaction with the computing device.

Example 18 includes the subject matter of any of Examples 1-17, and further including a secure storage to store the authenticated hair follicle pattern, and wherein to retrieve the authenticated hair follicle pattern comprises to retrieve an authenticated hair follicle pattern from the secure storage.

Example 19 includes the subject matter of any of Examples 1-18, and wherein to retrieve the authenticated hair follicle pattern comprises retrieve a template of the authenticated hair follicle pattern.

Example 20 includes the subject matter of any of Examples 1-19, and further including a communication module to transmit, in response to authentication of the user by the authentication module, a notification to a remote computing device that the user has been authenticated.

Example 21 includes a method for authenticating a user comprises to a computing device, the method comprising capturing, by a camera, an image of a portion of the user's skin while the computing device is in a locked state; determining, by the computing device, a hair follicle pattern of the portion of the user's skin based on the captured image; retrieving, by the computing device, an authenticated hair follicle pattern; comparing, by the computing device, the determined hair follicle pattern and the authenticated hair follicle pattern; and authenticating, by the computing device, the user based on the comparison of the determined hair follicle pattern and the authenticated hair follicle pattern.

Example 22 includes the subject matter of Example 21, and wherein determining the hair follicle pattern of the portion of the user's skin comprises identifying, in the captured image, a plurality of hair strands of the user extending from the portion of the user's skin; locating a hair follicle in the captured image for each identified hair strand; and determining a hair follicle pattern based on the located hair follicles.

Example 23 includes the subject matter of any of Examples 21 and 22, and wherein locating the hair follicle for each identified hair strand comprises tracing each hair strand to a corresponding hair follicle of the portion of the user's skin depicted in the captured image.

Example 24 includes the subject matter of any of Examples 21-23, and wherein determining the hair follicle pattern of the portion of the user's skin comprises determining a plurality of hair follicle sub-patterns of the portion of the user's skin based on the captured image, wherein the hair follicle pattern comprises the plurality of hair follicle sub-patterns.

Example 25 includes the subject matter of any of Examples 21-24, and wherein determining the hair follicle pattern of the portion of the user's skin comprises determining a landmark hair follicle sub-pattern of the portion of the user's skin and determining at least one additional hair follicle sub-pattern based on the landmark hair follicle sub-pattern, wherein the hair follicle pattern comprises the landmark hair follicle sub-pattern and the additional hair follicle sub-pattern.

Example 26 includes the subject matter of any of Examples 21-25, and wherein comparing the determined hair follicle pattern and the authenticated hair follicle pattern comprises comparing an image of the determined hair follicle pattern and an image of the authenticated hair follicle pattern.

Example 27 includes the subject matter of any of Examples 21-26, and wherein comparing the determined hair follicle pattern and the authenticated hair follicle pattern comprises comparing first data indicative of the determined hair follicle pattern and second data indicative of the authenticate hair follicle pattern.

Example 28 includes the subject matter of any of Examples 21-27, and wherein comparing the determined hair follicle pattern and the authenticated hair follicle pattern comprises determining whether the determined hair follicle pattern and the authenticate hair follicle pattern match.

Example 29 includes the subject matter of any of Examples 21-28, and wherein authenticating the user comprises unlocking the computing device in response to a determination that the determined hair follicle pattern and the authenticate hair follicle pattern match.

Example 30 includes the subject matter of any of Examples 21-29, and wherein authenticating the user comprises enabling a feature of the computing device that is identified based on the authenticated hair follicle pattern.

Example 31 includes the subject matter of any of Examples 21-30, and wherein authenticating the user comprises authenticating the user based on (i) the comparison of the determined hair follicle pattern and the authenticated hair follicle pattern and (ii) at least one additional biometric authentication of another physical trait of the user.

Example 32 includes the subject matter of any of Examples 21-31, and wherein authenticating the user comprises authenticating the user based on the combination of the authenticated hair follicle pattern and the another physical trait.

Example 33 includes the subject matter of any of Examples 21-32, and wherein authenticating the user comprising enabling a feature of the computing device that is identified based on the combination of the authenticated hair follicle pattern and the another physical trait.

Example 34 includes the subject matter of any of Examples 21-33, and wherein capturing the image of the portion of the user's skin comprises capturing an image of the portion of the user's skin with a camera incorporated in the computing device.

Example 35 includes the subject matter of any of Examples 21-34, and wherein capturing the image of the portion of the user's skin comprises capturing an image of the portion of the user's skin with a camera separate from the computing device and communicatively coupled to the computing device.

Example 36 includes the subject matter of any of Examples 21-35, and wherein capturing the image of the portion of the user's skin comprises capturing an image of a portion of the user's skin located on the user's hand, arm, ear, or periorbital region.

Example 37 includes the subject matter of any of Examples 21-36, and further including enabling the camera while the computing device is in the unlocked state in response to a user interaction with the computing device.

Example 38 includes the subject matter of any of Examples 21-37, and wherein retrieving the authenticated hair follicle pattern comprises retrieving an authenticated hair follicle pattern from a secure storage of the computing device.

Example 39 includes the subject matter of any of Examples 21-38, and wherein retrieving the authenticated hair follicle pattern comprises retrieving a template of the authenticated hair follicle pattern.

Example 40 includes the subject matter of any of Examples 21-39, and further including transmitting, in response to authenticating the user, a notification to a remote computing device that the user has been authenticated.

Example 41 includes a computing device comprising a processor; and a memory having stored therein a plurality of instructions that when executed by the processor cause the computing device to perform the method of any of Examples 21-40.

Example 42 includes one or more machine-readable storage media comprising a plurality of instructions stored thereon that in response to being executed result in a computing device performing the method of any of Examples 21-40.

Example 43 includes a computing device for authenticating a user to a computing device, the computing device comprising means for capturing an image of a portion of the user's skin while the computing device is in a locked state; means for determining a hair follicle pattern of the portion of the user's skin based on the captured image; means for retrieving an authenticated hair follicle pattern; means for comparing the determined hair follicle pattern and the authenticated hair follicle pattern; and means for authenticating the user based on the comparison of the determined hair follicle pattern and the authenticated hair follicle pattern.

Example 44 includes the subject matter of Example 43, and wherein the means for determining the hair follicle pattern of the portion of the user's skin comprises means for identifying, in the captured image, a plurality of hair strands of the user extending from the portion of the user's skin; means for locating a hair follicle in the captured image for each identified hair strand; and means for determining a hair follicle pattern based on the located hair follicles.

Example 45 includes the subject matter of any of Examples 43 and 44, and wherein the means for locating the hair follicle for each identified hair strand comprises means for tracing each hair strand to a corresponding hair follicle of the portion of the user's skin depicted in the captured image.

Example 46 includes the subject matter of any of Examples 43-45, and wherein the means for determining the hair follicle pattern of the portion of the user's skin comprises means for determining a plurality of hair follicle sub-patterns of the portion of the user's skin based on the captured image, wherein the hair follicle pattern comprises the plurality of hair follicle sub-patterns.

Example 47 includes the subject matter of any of Examples 43-46, and wherein the means for determining the hair follicle pattern of the portion of the user's skin comprises means for determining a landmark hair follicle sub-pattern of the portion of the user's skin and means for determining at least one additional hair follicle sub-pattern based on the landmark hair follicle sub-pattern, wherein the hair follicle pattern comprises the landmark hair follicle sub-pattern and the additional hair follicle sub-pattern.

Example 48 includes the subject matter of any of Examples 43-47, and wherein the means for comparing the determined hair follicle pattern and the authenticated hair follicle pattern comprises means for comparing an image of the determined hair follicle pattern and an image of the authenticated hair follicle pattern.

Example 49 includes the subject matter of any of Examples 43-48, and wherein the means for comparing the determined hair follicle pattern and the authenticated hair follicle pattern comprises means for comparing first data indicative of the determined hair follicle pattern and second data indicative of the authenticate hair follicle pattern.

Example 50 includes the subject matter of any of Examples 43-49, and wherein the means for comparing the determined hair follicle pattern and the authenticated hair follicle pattern comprises means for determining whether the determined hair follicle pattern and the authenticate hair follicle pattern match.

Example 51 includes the subject matter of any of Examples 43-50, and wherein the means for authenticating the user comprises means for unlocking the computing device in response to a determination that the determined hair follicle pattern and the authenticate hair follicle pattern match.

Example 52 includes the subject matter of any of Examples 43-51, and wherein the means for authenticating the user comprises means for enabling a feature of the computing device that is identified based on the authenticated hair follicle pattern.

Example 53 includes the subject matter of any of Examples 43-52, and wherein the means for authenticating the user comprises means for authenticating the user based on (i) the comparison of the determined hair follicle pattern and the authenticated hair follicle pattern and (ii) at least one additional biometric authentication of another physical trait of the user.

Example 54 includes the subject matter of any of Examples 43-53, and wherein the means for authenticating the user comprises means for authenticating the user based on the combination of the authenticated hair follicle pattern and the another physical trait.

Example 55 includes the subject matter of any of Examples 43-54, and wherein the means for authenticating the user comprising means for enabling a feature of the computing device that is identified based on the combination of the authenticated hair follicle pattern and the another physical trait.

Example 56 includes the subject matter of any of Examples 43-55, and wherein the means for capturing the image of the portion of the user's skin comprises means for capturing an image of the portion of the user's skin with a camera incorporated in the computing device.

Example 57 includes the subject matter of any of Examples 43-56, and wherein the means for capturing the image of the portion of the user's skin comprises means for capturing an image of the portion of the user's skin with a camera separate from the computing device and communicatively coupled to the computing device.

Example 58 includes the subject matter of any of Examples 43-57, and wherein the means for capturing the image of the portion of the user's skin comprises means for capturing an image of a portion of the user's skin located on the user's hand, arm, ear, or periorbital region.

Example 59 includes the subject matter of any of Examples 43-58, and further including means for enabling the camera while the computing device is in the unlocked state in response to a user interaction with the computing device.

Example 60 includes the subject matter of any of Examples 43-59, and wherein the means for retrieving the authenticated hair follicle pattern comprises means for retrieving an authenticated hair follicle pattern from a secure storage of the computing device.

Example 61 includes the subject matter of any of Examples 43-60, and wherein the means for retrieving the authenticated hair follicle pattern comprises means for retrieving a template of the authenticated hair follicle pattern.

Example 62 includes the subject matter of any of Examples 43-61, and further including means for transmitting, in response to authenticating the user, a notification to a remote computing device that the user has been authenticated.

1-25. (canceled)

26. A computing device for authenticating a user based on a physical trait, the computing device comprising:
a biometric capture module to receive an image of a portion of user's skin from a camera while the computing device is in a locked state;
an authentication module to determine a hair follicle pattern of the portion of the user's skin based on the image, retrieve the authenticated hair follicle pattern, compare the determined hair follicle pattern and the authenticated hair follicle pattern, and authenticate the user based on the comparison of the determined hair follicle pattern and the authenticated hair follicle pattern.

27. The computing device of claim 26, wherein to determine the hair follicle pattern of the portion of the user's skin comprises to:
identify, in the image, a plurality of hair strands of the user extending from the portion of the user's skin;
locate a hair follicle in the image for each identified hair strand; and
determine a hair follicle pattern based on the located hair follicles.

28. The computing device of claim 27, wherein to locate the hair follicle for each identified hair strand comprises to trace each hair strand to a corresponding hair follicle of the portion of the user's skin depicted in the image.

29. The computing device of claim 26, wherein to compare the determined hair follicle pattern and the authenticated hair follicle pattern comprises to compare an image of the determined hair follicle pattern and an image of the authenticated hair follicle pattern.

30. The computing device of claim 26, wherein to compare the determined hair follicle pattern and the authenticated hair follicle pattern comprises to compare first data indicative of the determined hair follicle pattern and second data indicative of the authenticate hair follicle pattern.

31. The computing device of claim 26, wherein:
to compare the determined hair follicle pattern and the authenticated hair follicle pattern comprises to determine whether the determined hair follicle pattern and the authenticate hair follicle pattern match, and
to authenticate the user comprises to unlock the computing device in response to a determination that the determined hair follicle pattern and the authenticate hair follicle pattern match.

32. The computing device of claim 26, wherein to authenticate the user comprises to enable a feature of the computing device that is identified based on the authenticated hair follicle pattern.

33. The computing device of claim 26, wherein to authenticate the user comprises to authenticate the user based on (i) the comparison of the determined hair follicle pattern and the authenticated hair follicle pattern and (ii) at least one additional biometric authentication of another physical trait of the user.

34. The computing device of claim 33, wherein to authenticate the user comprises to enable a feature of the computing device that is identified based on the combination of the authenticated hair follicle pattern and the another physical trait.

35. The computing device of claim 26, wherein the biometric capture module is further to enable the camera while the computing device is in the unlocked state in response to a user interaction with the computing device.

36. One or more machine-readable storage media comprising a plurality of instructions stored thereon, which in response to execution, cause a computing device to:
capture an image of a portion of the user's skin while the computing device is in a locked state;
determine a hair follicle pattern of the portion of the user's skin based on the captured image;
retrieve an authenticated hair follicle pattern;
compare the determined hair follicle pattern and the authenticated hair follicle pattern; and
authenticate the user based on the comparison of the determined hair follicle pattern and the authenticated hair follicle pattern.

37. The one or more machine-readable storage media of claim 36, wherein to determine the hair follicle pattern of the portion of the user's skin comprises to:
identify a plurality of hair strands of the user extending from the portion of the user's skin;
locate a hair follicle in the captured image for each identified hair strand; and
determine a hair follicle pattern based on the located hair follicles.

38. The one or more machine-readable storage media of claim 37, wherein to locate the hair follicle for each identified hair strand comprises to trace each hair strand to a corresponding hair follicle of the portion of the user's skin depicted in the captured image.

39. The one or more machine-readable storage media of claim 36, wherein to compare the determined hair follicle pattern and the authenticated hair follicle pattern comprises to compare an image of the determined hair follicle pattern and an image of the authenticated hair follicle pattern.

40. The one or more machine-readable storage media of claim 36, wherein to compare the determined hair follicle pattern and the authenticated hair follicle pattern comprises to compare first data indicative of the determined hair follicle pattern and second data indicative of the authenticate hair follicle pattern.

41. The one or more machine-readable storage media of claim 36, wherein:
to compare the determined hair follicle pattern and the authenticated hair follicle pattern comprises to determine whether the determined hair follicle pattern and the authenticate hair follicle pattern match, and
to authenticate the user comprises to unlock the computing device in response to a determination that the determined hair follicle pattern and the authenticate hair follicle pattern match.

42. The one or more machine-readable storage media of claim 36, wherein to authenticate the user comprises to enable a feature of the computing device that is identified based on the authenticated hair follicle pattern.

43. The one or more machine-readable storage media of claim 36, wherein to authenticate the user comprises to authenticate the user based on (i) the comparison of the determined hair follicle pattern and the authenticated hair follicle pattern and (ii) at least one additional biometric authentication of another physical trait of the user.

44. A method for authenticating a user to a computing device, the method comprising:
capturing, by a camera, an image of a portion of the user's skin while the computing device is in a locked state;
determining, by the computing device, a hair follicle pattern of the portion of the user's skin based on the captured image;
retrieving, by the computing device, an authenticated hair follicle pattern;
comparing, by the computing device, the determined hair follicle pattern and the authenticated hair follicle pattern; and
authenticating, by the computing device, the user based on the comparison of the determined hair follicle pattern and the authenticated hair follicle pattern.

45. The method of claim 44, wherein determining the hair follicle pattern of the portion of the user's skin comprises:
identifying, in the captured image, a plurality of hair strands of the user extending from the portion of the user's skin;
locating a hair follicle in the captured image for each identified hair strand; and
determining a hair follicle pattern based on the located hair follicles.

46. The method of claim 45, wherein locating the hair follicle for each identified hair strand comprises tracing each hair strand to a corresponding hair follicle of the portion of the user's skin depicted in the captured image.

47. The method of claim 44, wherein comparing the determined hair follicle pattern and the authenticated hair follicle pattern comprises comparing an image of the determined hair follicle pattern and an image of the authenticated hair follicle pattern.

48. The method of claim 44, wherein:
comparing the determined hair follicle pattern and the authenticated hair follicle pattern comprises determining whether the determined hair follicle pattern and the authenticate hair follicle pattern match, and
authenticating the user comprises unlocking the computing device in response to a determination that the determined hair follicle pattern and the authenticate hair follicle pattern match.

49. The method of claim 44, wherein authenticating the user comprises enabling a feature of the computing device that is identified based on the authenticated hair follicle pattern.

50. The method of claim 44, wherein authenticating the user comprises authenticating the user based on (i) the comparison of the determined hair follicle pattern and the authenticated hair follicle pattern and (ii) at least one additional biometric authentication of another physical trait of the user.
